(19) United States
(12) Patent Application Publication
(10) Pub. No.: US 2012/0232917 A1
(43) Pub. Date: Sep. 13, 2012

(54) SYSTEM AND METHOD FOR WIRELESS RESERVATION AND ORDERING FROM A MOBILE DEVICE

(75) Inventors: BASHAR NAZIH AL-KHUDAIRY, MISHREF (KW); ABDUL-AZIZ RASHID AL-AZMI, ADAN (KW); ABDULRAHMAN RASHID ALAZMI, ADAN (KW)

(73) Assignee: KUWAIT UNIVERSITY, SAFAT (KW)

(21) Appl. No.: 13/044,259

(22) Filed: Mar. 9, 2011

(51) Int. Cl. G06Q 10/00; G06Q 30/00; G06Q 50/00

(52) U.S. Cl. 705/2; 705/5; 705/26.1; 705/15

(57) ABSTRACT

The system and method for wireless reservation and ordering from a mobile device includes a server that provides a relational database accessible to a client mobile device via a Wi-Fi interface. A browser operable on the client mobile device accesses the relational database to provide a catalog of restaurants, coffee shops, hospitals, malls, barber shops, and the like, from which the user can view menus, receive offers, make reservations, order items and services. The proximity requirement of Wi-Fi makes the system a Location Based Service (LBS).

### BACKGROUND OF THE INVENTION

1. Field of the Invention

The present invention relates to wireless communication systems, and more specifically to a system and method for wireless reservation and ordering from a mobile device.

2. Description of the Related Art

More and more services are now shifting towards mobile phones. To mention a few, we have: live conferencing, live TV, and GPS. Such applications utilize the mobile's network capabilities that have emerged. Some new mobile phones are now part of the Wi-Fi and can have full Internet access, and use much functionality from the Web for this, such as photography, live conferencing, Internet access, and messages. Mobile phones are reaching more and more audience, and covering more ground in functionality.

Traffic jams caused by ad hoc trips and the disappointment that results from not finding a parking place, a table, or even the item that people were looking for are common occurrences in modern life. There is a need to reduce traffic and the consequent air pollution that harm our environment, a need to increase client satisfaction, and a need to increase sales for the participating companies.

Thus, a system and method for wireless reservation and ordering from a mobile device solving the aforementioned problems is desired.

### SUMMARY OF THE INVENTION

The system and method for wireless reservation and ordering from a mobile device includes a server and a merchant database accessible to a client mobile device via a Wi-Fi interface. A browser operable on the client mobile device provides a catalog of restaurants, coffee shops, hospitals, malls, barber shops, and the like, from which the user can view menus, receive offers, make reservations, order items and services. The proximity requirement of Wi-Fi makes the system a Location Based Service (LBS).

These and other features of the present invention will become readily apparent upon further review of the following specification and drawings.

### BRIEF DESCRIPTION OF THE DRAWINGS

FIG. 1 is a block diagram of the wireless reservation and ordering system according to the present invention.

FIG. 2 is an entity relationship diagram showing exemplary logical entities included in a database for making restaurant reservations in a system and method for wireless reservation and ordering from a mobile device.

FIG. 3 is an entity relationship diagram showing exemplary logical entities included in a database for making salon reservations in a system and method for wireless reservation and ordering from a mobile device.

FIG. 4 is an entity relationship diagram showing exemplary logical entities included in a database for making coffee shop reservations in a system and method for wireless reservation and ordering from a mobile device.

FIG. 5 is an entity relationship diagram showing exemplary logical entities included in a database for making clinic reservations in a system and method for wireless reservation and ordering from a mobile device.

FIG. 6 is a block diagram showing exemplary information and menu selections available on a mobile device for making shopping mall reservations in a system and method for wireless reservation and ordering from a mobile device.

FIG. 7 is a block diagram showing exemplary steps for making restaurant reservations in a system and method for wireless reservation and ordering from a mobile device.

FIG. 8 is a block diagram showing exemplary steps for making hotel reservations in a system and method for wireless reservation and ordering from a mobile device.

FIG. 9 is a block diagram showing exemplary steps for making shopping mall reservations in a system and method for wireless reservation and ordering from a mobile device.

FIG. 10 is a block diagram showing exemplary steps for making clinic or hospital reservations in a system and method for wireless reservation and ordering from a mobile device.

FIG. 11 is a block diagram showing exemplary steps for making salon or barber reservations in a system and method for wireless reservation and ordering from a mobile device.

FIG. 12A is an exemplary splash screenshot on a mobile device of an entry screen of software implementing a system and method for wireless reservation and ordering from a mobile device.

FIG. 12B is an exemplary service selection menu screenshot of software implementing a system and method for wireless reservation and ordering from a mobile device.

FIG. 13A is an exemplary reserve table menu for restaurants screenshot of software implementing a system and method for wireless reservation and ordering from a mobile device.

FIG. 138 is an exemplary restaurant reservation timeslot entry screenshot of software implementing a system and method for wireless reservation and ordering from a mobile device.

FIG. 14A is an exemplary clinic appointment entry page screenshot of software implementing a system and method for wireless reservation and ordering from a mobile device.

FIG. 148 is an exemplary clinic reserve appointment menu page screenshot of software implementing a system and method for wireless reservation and ordering from a mobile device.

FIG. 14C is an exemplary set clinic appointment page screenshot of software implementing a system and method for wireless reservation and ordering from a mobile device.

Similar reference characters denote corresponding features consistently throughout the attached drawings.

### DETAILED DESCRIPTION OF THE PREFERRED EMBODIMENTS

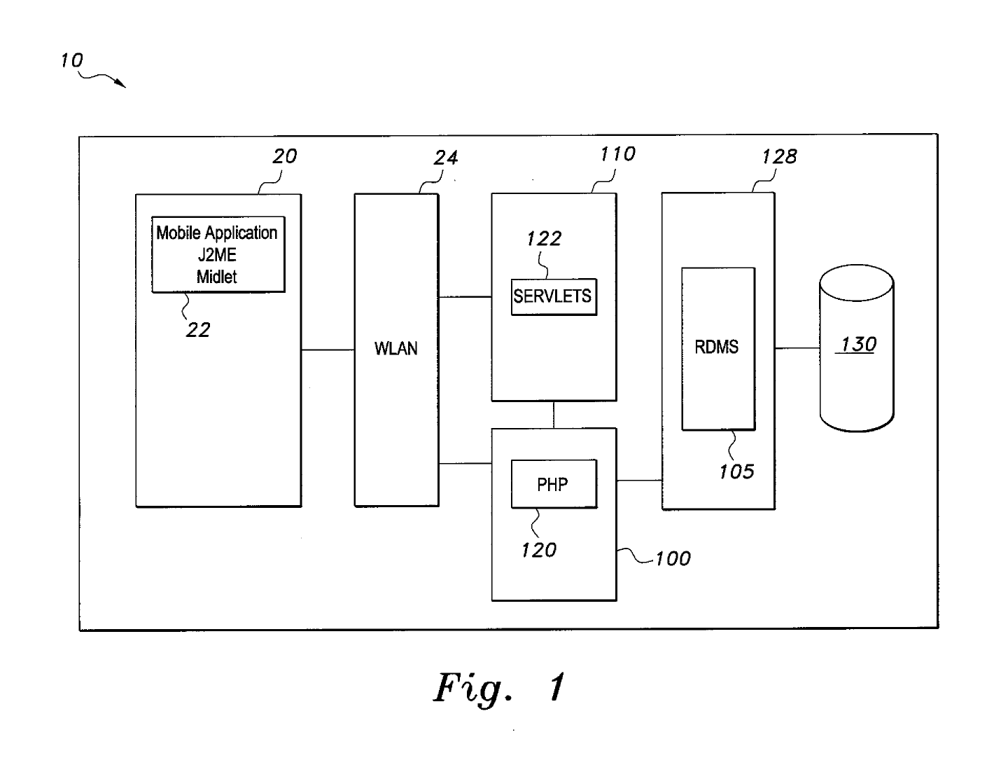

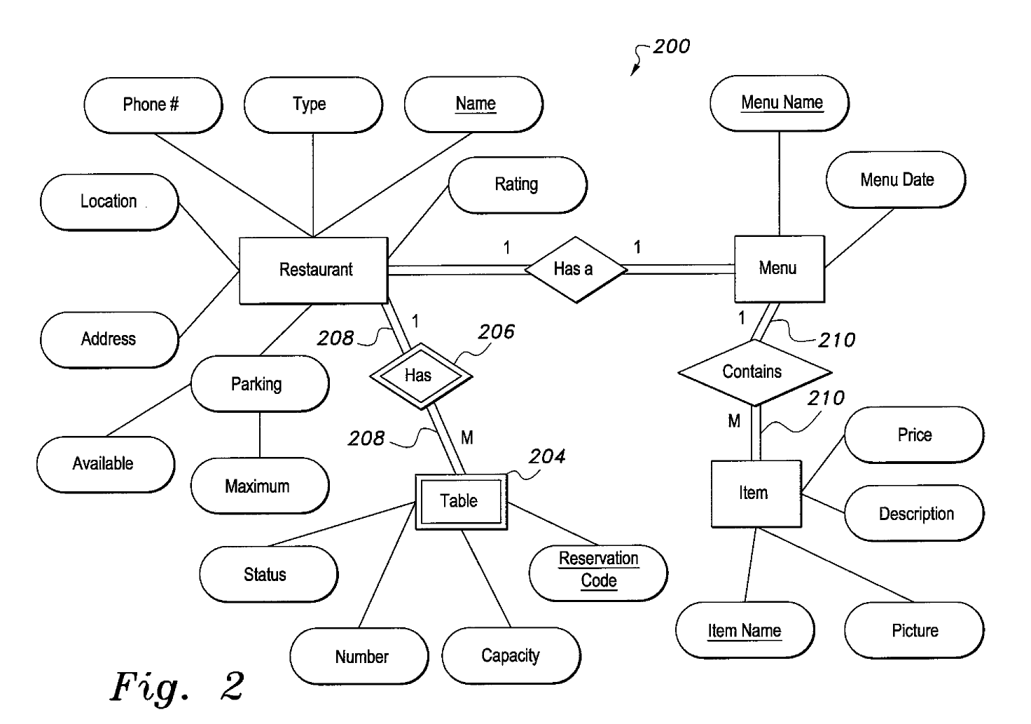

As shown in FIG. 1, the wireless reservation and ordering system 10 includes a plurality of servers and a relational database 130 accessible via a Wi-Fi interface 24 to a client mobile device 20 running a mobile ordering application 22. A browser operable on the client mobile device 20 provides a catalogue of restaurants, coffee shops, hospitals, malls, barber shops, and the like, from which the user can view menus, receive offers, make reservations, and order items and services. The proximity requirement of Wi-Fi makes the system 10 a Location Based Service (LBS). Moreover additional location-based features may be implemented using GPS technology, which is available on most user mobile devices 20. For example, through using GPS technology, it is possible to allocate (find nearby available) restaurants. The system 10 provides the user with the capability to search through a global information system (GIS), view menus, make a reservation, find empty seats, order food, and the like. The mobile phone 20 preferably has Wi-Fi capabilities and a valid GPRS subscription from a network provider. The mobile device 20 preferably includes a processor for processing executable instructions, a display coupled to the processor for displaying images and text, a wireless interface coupled to the processor configured to send and receive wireless signals, and a memory device arranged to store data.

The visual browser on the client device 20 guides users to new services, new offers, available parking, available seats, available hotel rooms, and the like.

The client mobile device 20 runs a dedicated program, i.e., the mobile application 22, which wirelessly connects to a dedicated web server 100. This wireless communication link allows extraction and registration of data from the transaction database 130, which is service-oriented and connected to a database server 128. Permissible transactions include registration, item and service ordering, reservation making, and/or receiving special offers from participating vendors. As soon as the mobile application 22 is started, it will locate all services and merchants near the mobile device 20. Also, it will allow ads and offers to reach the user of mobile device 20.

The system 10 is built on a distributed multi-tier client/server architecture, since its services are divided between the clients and at least one server. The system 10 includes a mobile interface layer, a web server layer, and a database layer.

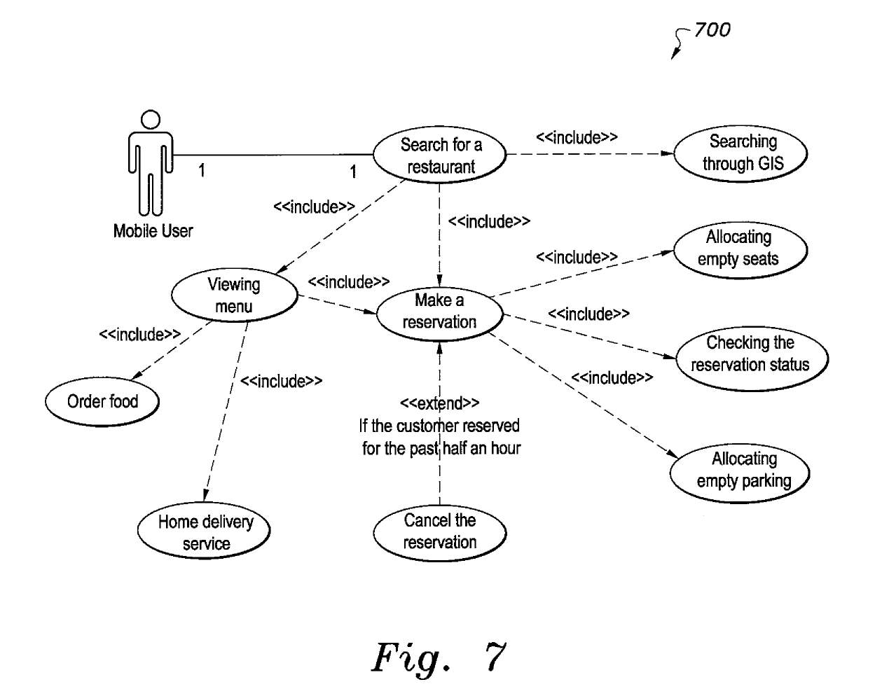

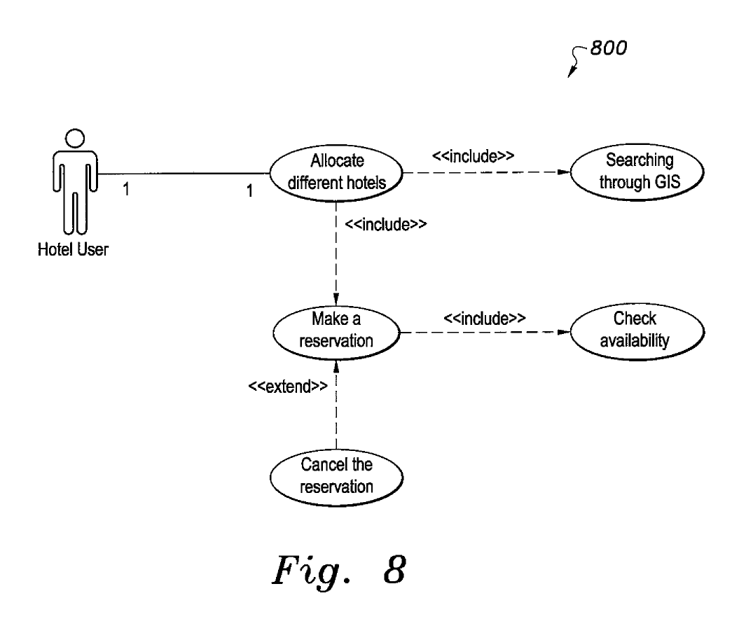

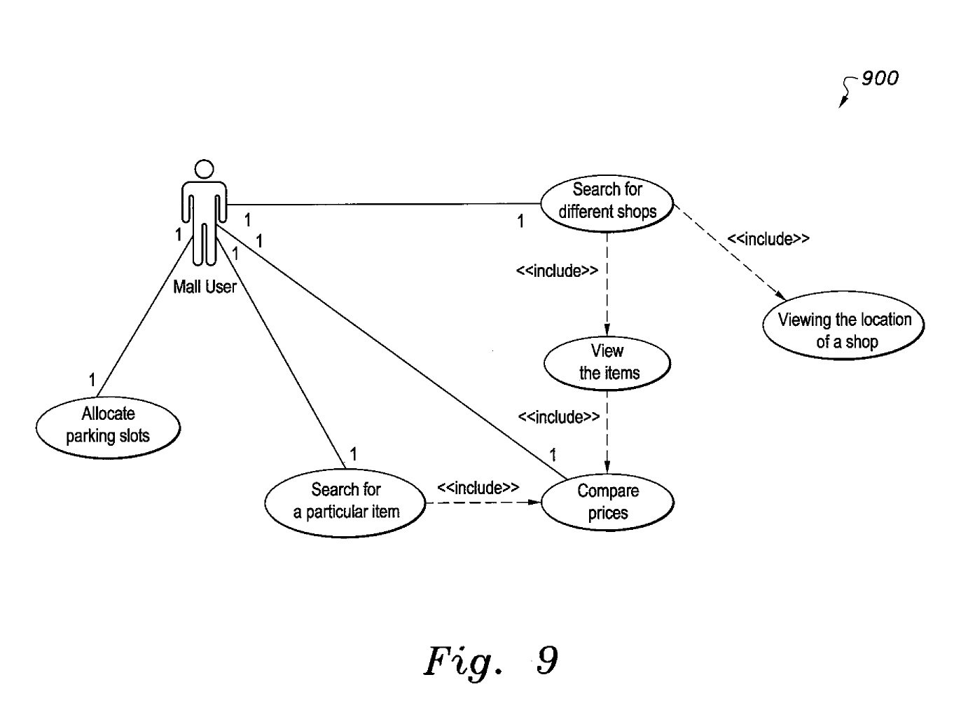

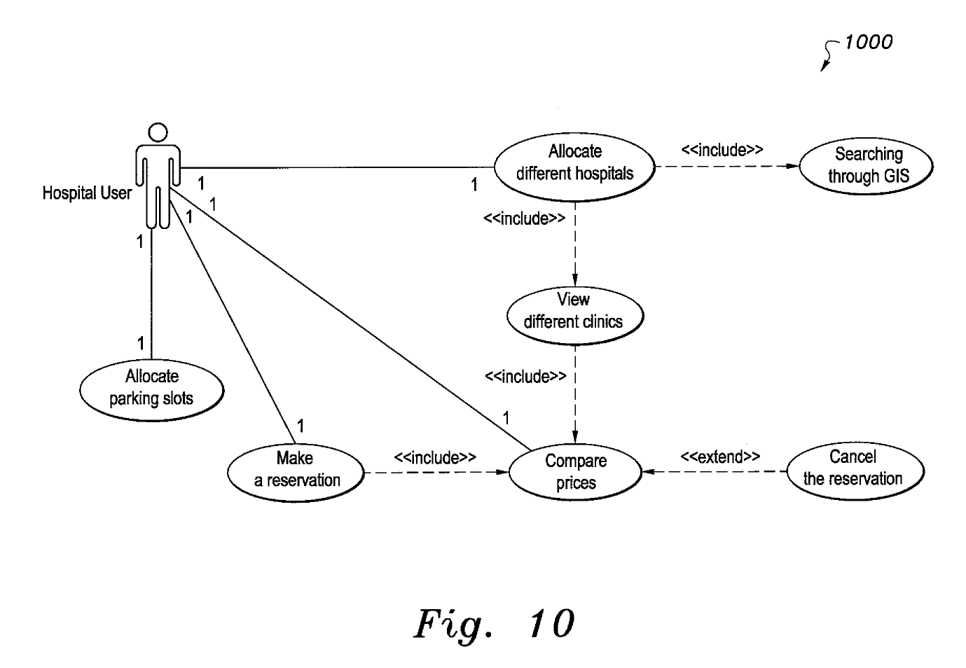

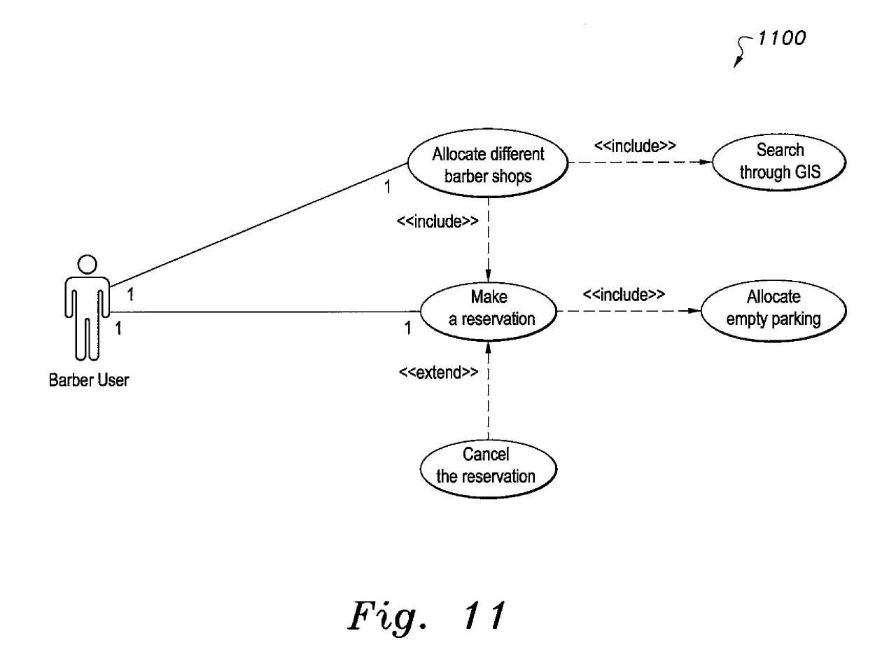

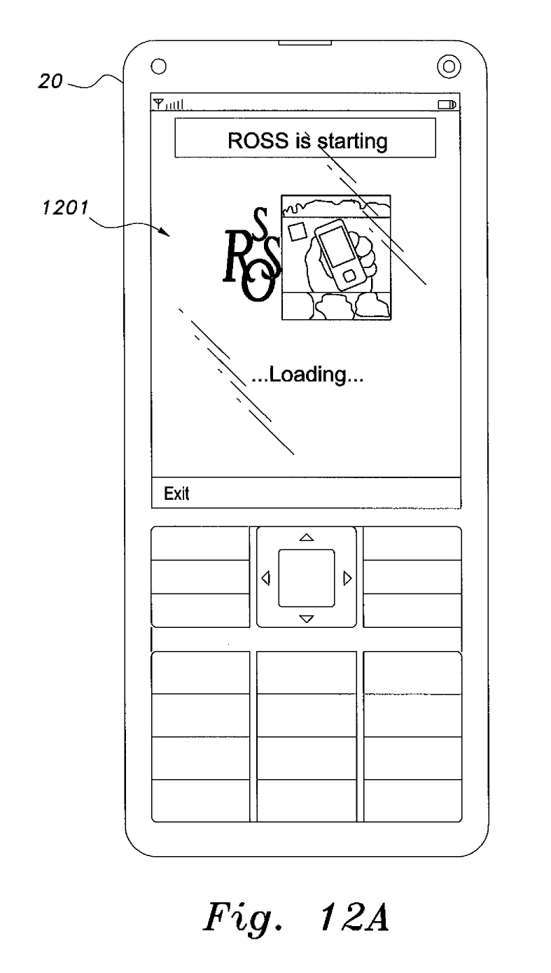

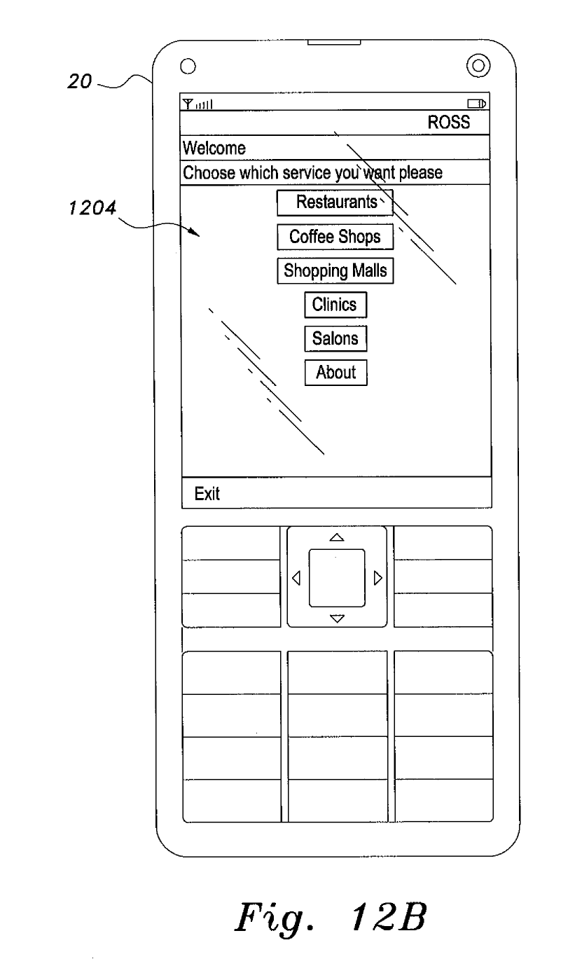

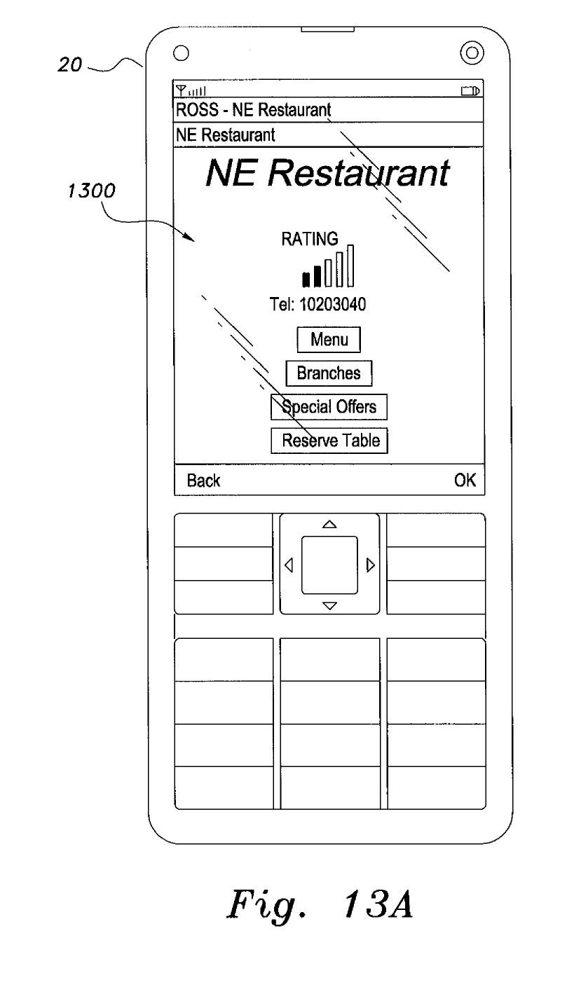

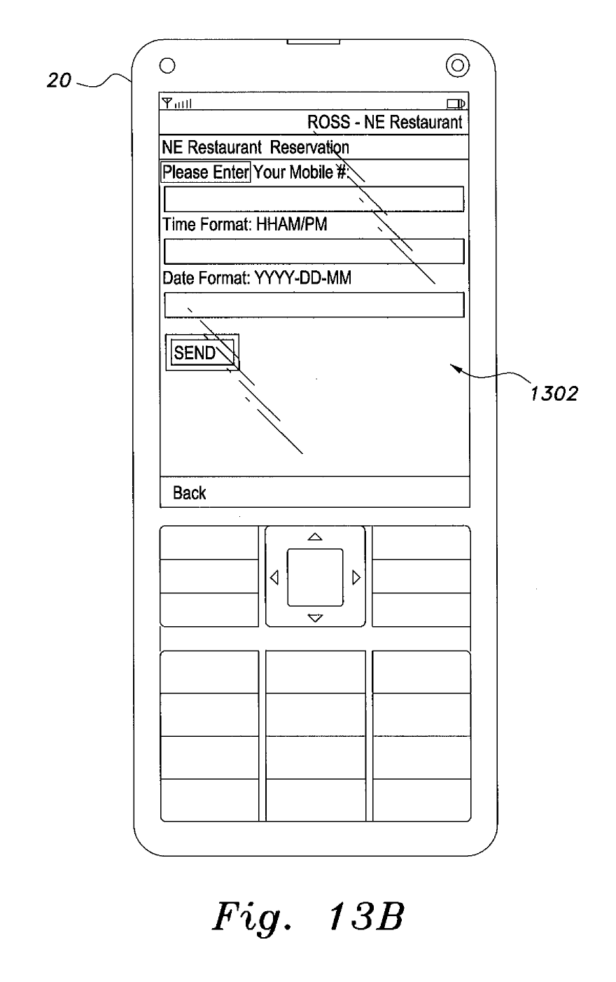

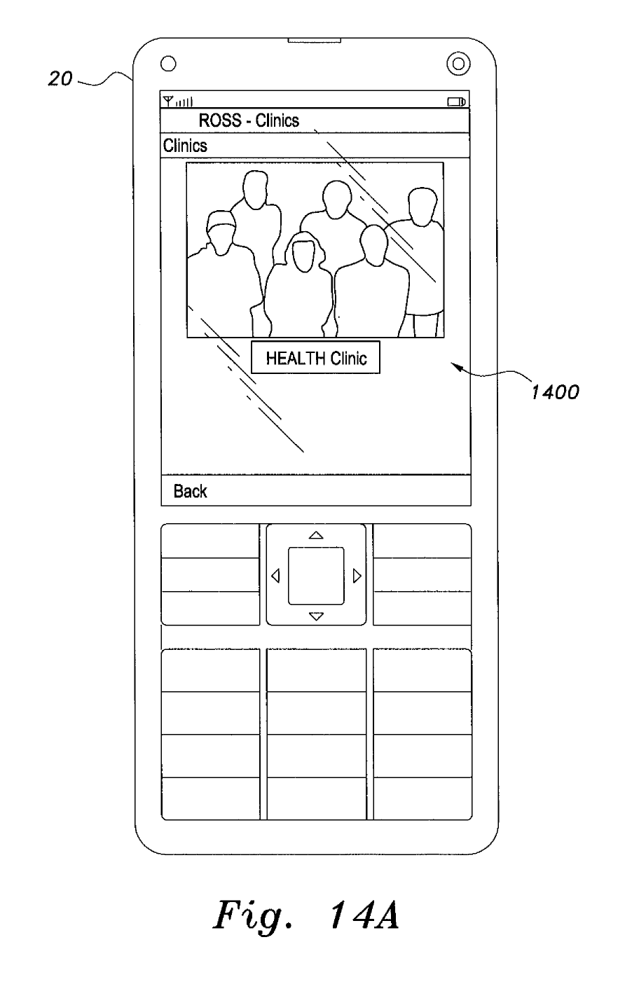

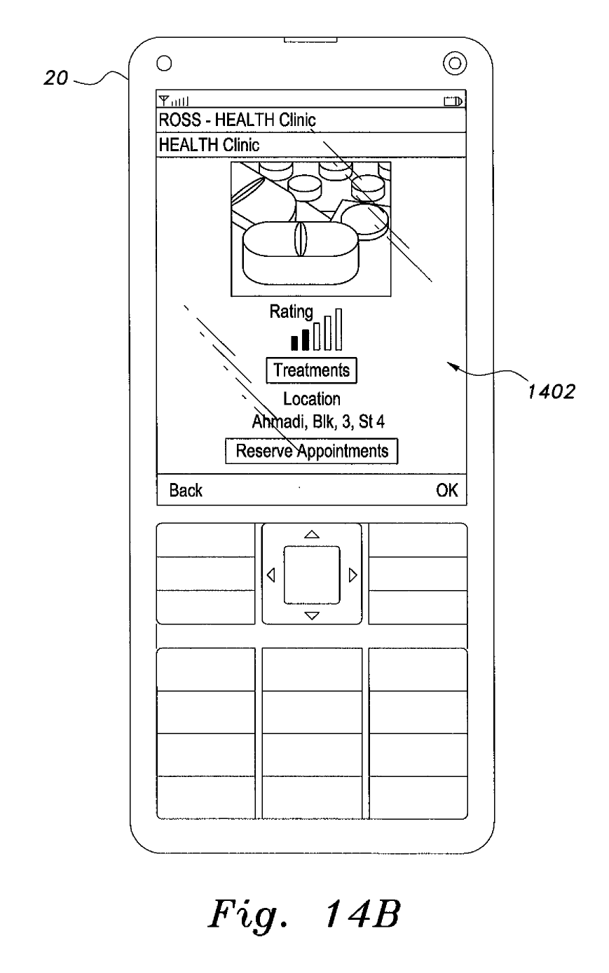

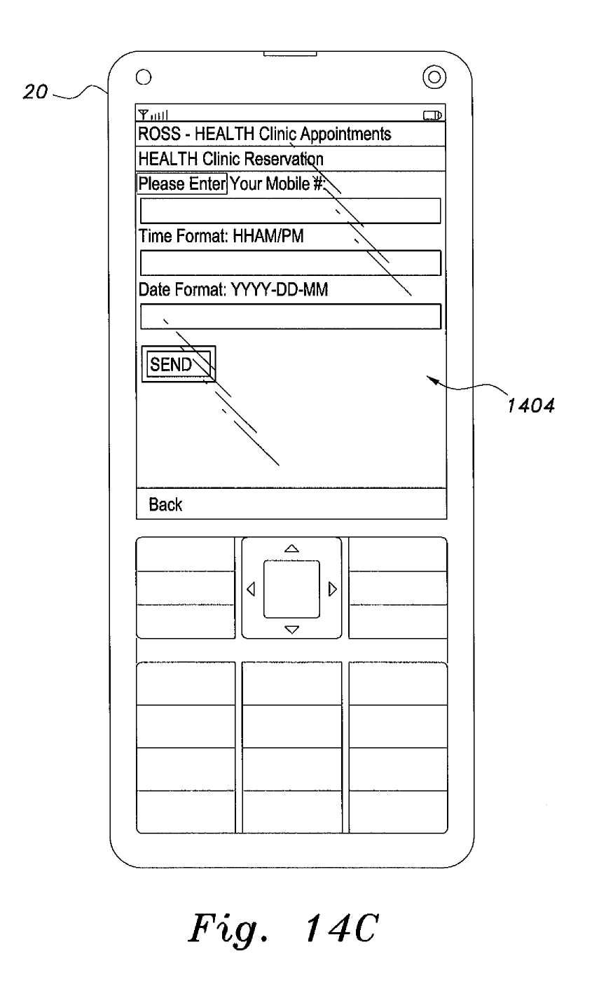

The mobile Interface provides an interface through which an end user can access the system's services. For example, as shown in FIG. 12A a startup splash screen 1201 is presented when the mobile software application is starting up on the mobile device 20. As shown in FIG. 12B, a graphical user interface (GUI) has a menu 1204, which is provided for ease of navigation through the services, products, and reservations offered. Table reservation (FIG. 13A, 1300) and appointment reservation (FIG. 13B, 1302) menus are included. Additionally, a parking availability menu is provided from which parking availability (FIG. 7, 700, FIG. 9, 900, FIG. 10, 1000, and FIG. 11, 1100) can be checked in the vicinity of restaurants, malls, clinics, and the like. Merchandise can be ordered from retailers. Food items can be ordered from restaurants. Similarly, as shown in FIGS. 14A-14C, an end user can find and make appointments at nearby clinics utilizing an intro screen 1400, a reserve appointments screen 1402, and an appointment data entry screen 1404.

As shown in FIG. 1, the mobile layer 20, using mobile application 22, communicates via a WLAN 24 (e.g., 802.11 WiFi) to invoke a servlet 122 running on an application server 110, which, in turn, communicates with the web server 100 via PHP code 120 (layer2) in order to POST or GET data from the database 130, which is managed by a relational database management system (RDBMS) 105 running on a database server 128, as required for reservation operations or parking availability checking or other data storage or retrieval operations.

As shown in FIGS. 13B and 14C, the user interface 1302, 1404 provided by the mobile application 22 accepts entry of the user's cell phone number, service requested, and time and date desired for the ordered service. The system then responds with the available time and date for the service ordered by the user.

The Web Server 100 handles all requests from the servlets 122 on the application server 110 by querying and updating the database 130 as required. Restaurants and their menus, hotels and their addresses, clinics and their types of treatment are stored in the database 130. Database 130 may be controlled and maintained by appropriate merchant personnel.

The system database 130 is preferably a relational database managed by a relational database management system 105 (RDBMS), such as MYSQL. The business logic of the database 130 is reflected in the entity relationship diagrams shown in FIGS. 2 through 6.

The server and the database provide multi-user login, group permissions, data navigation, sorting, searching, modification, addition, deletion and advanced filtering that enables a maintenance user to formulate complex SQL statements without knowing programming. Foreign key constraints are added to preserve referential integrity, as required. Preferably, the database 130 is maintained by system managers via Internet access to web pages having PHP code 120.

The exemplary web server 100 is an Apache server, which serves both static content and dynamic web pages on the World Wide Web. The system 10 stores the PHP files in the Apache web server 100, where the PHP code 120 facilitates connections to the MySQL database 130. This configuration allows the administrator to execute any desired SQL statement while having full permissions to the database 130.

The exemplary application server used is Glassfish, which is an open source Java project. The system's application server 110 runs in a distributed computer network and provides the business logic for the application programs, e.g., servlets 122. The application server is used to connect through the servlets 122 to retrieve, add, modify, or delete data stored in the database. This process is called from a J2ME application, where it accesses the servlet 122, and the servlet 122 then accesses the web server 100, which, in turn, accesses the database server 128 to perform the database transactions required and return the requested data back to the mobile application 22 running on the mobile device 20. Servlet handling of the application utilizes multi-threading. The exemplary servlets 122 are programmed in Java. Servlets 122 are used instead of direct HTTP connections. A plurality of complex servlets 122 are configured between the client side Midlet 22 and the server side database 130.

The web server 100 provides a plurality of screens, including a main login screen where the administrator or other database maintenance user can login in.

The database 130 can be created using BigProf Software's AppGini, a program available on the Internet. The program automatically generates the database 130 and the PHP code 120 to run the database 130 from the Apache web server 100 based on the user description of the required tables. Utilizing the user supplied table descriptions, AppGini will create the tables described in the ER diagrams of FIGS. 2-6 and write the PHP code 120. The developer need only take the AppGini generated files and place them in the www root file in the Apache web server 100. The system software that runs the Apache web server 100, PHP code 120, and the database server 128 for the MySQL database 130 may be Mac OS X 10.5 Leopard.

A service provider's portion of the system 10 comprises database and web administration tools that are simple to use. Since, as shown in FIG. 1, the system database 130 is web enabled, administrators need only navigate to the local domain name while running the web server 100 for access to the PHP pages 120 that AppGini created.

A popup allowing the user to enter her/his name and pin code is provided for administrator entry into the system, where she/he can view, update, delete, and insert into the system. The database table instances are also created effortlessly via the third party developer's tool, AppGini.

The software accessible to administrators and other service providers preferably has a high-speed broadband (e.g., ADSL) connection, and a web browser running on a typical workstation. Moreover, the workstations preferably support PHP because the web-enabled database is in PHP, i.e., not in ASPX or any .NET platforms. It should be understood that Microsoft Windows Vista does not support PHP. Therefore other operating systems that support PHP are needed on the workstations.

A client's portion of the system 10 provides service for the mobile devices operated by the intended end users of the system. The system provides downloadable software, which the end user downloads into his/her web-enabled mobile device. The end user mobile device preferably has a GPRS subscription from an appropriate mobile network provider. Once the mobile application software is downloaded to the mobile device, the end users can access all system functionalities via the mobile network.

In the preferred embodiment, the hardware needed is a fast, mid=level web server, capable of serving hundred of users at the same time. For the database server, ROSS needs a hot swappable RAID2 or RAID1 database server that will keep the database functional under heavy traffic and transactions.

In the preferred embodiment, the hardware requirement for the end users is a connected device limited configuration CDLC 2.0 Wi-Fi mobile phone, running an operating system supporting J2ME, e.g., Symbian S60. Thus, the mobile application Midlet 22 is compatible with the mobile phone 20.

Users of the system are split into service provider and end user categories. The service provider category users are further divided into system administrators and system operators. The system administrators are skilled IT employees who keep the database and the website running. They maintain, backup, and update the system. The system operators run the system and check reservations, such as the reserved parking, appointment, and stylists.

The end users are all users of mobile phones having the mobile application. The system, also known as Reserve Order Suite System (ROSS), is very easy to use. Once downloaded, the installation is completed automatically by the mobile phone operating system. ROSS is ready to use by the mobile application without any further configuration. The mobile application has a menu-driven interface with simple button clicking and scrolling interactions that end users of all ages and backgrounds find user-friendly.

The system 10 provides a main screen for the restaurant reservation service, which offers users access to the functions shown in the diagram 700 of FIG. 7. The PHP code 120 includes a main screen for the Restaurant table, where a restaurant employee can insert the data needed, such as restaurant name, restaurant type, location on a map, phone number, available parking, maximum parking, rating according to customer's evaluation, and menu name from a drop down list. Similarly, as shown in the diagram 800 of FIG. 8, the hotel reservation use case flow allows the user to conduct a GIS search, check for availability, and make or cancel a reservation.

The system 10 has a menu table relation where the employee inserts instances that include a menu name and the date of creation. The third party APPGini provides the system 10 with an advanced filtering feature, which allows an administrative user to perform complex SQL queries without the knowledge of SQL. By merely entering a specific field and a specific filter, a comparison operator, and a value, the smart filtering can execute the query. The administrative user is allowed to perform twelve filters at a time, and can link with them using “and” and “or” operators. AppGini then generates the required code to execute the administrator-defined query from the filters.

Information can be retrieved from the database 130 and be shown to end users' mobile devices 20 when using the mobile application 22. An end user is allowed to make a quick search for a word or part of it by entering text in the required search field in a quick search area. When an end user reserves a table for a restaurant using the mobile application 22, the mobile application 22 will access the appropriate relation (as shown in FIG. 2 ER diagram 200) and automatically add the information. The mobile user is then presented food items for review from the items table, where restaurant's menus are stored. In the restaurant ER diagram 200 of FIG. 2, TABLE 204 is declared to be a weak entity set and the total participation constraint 208 is enforced on the relation HAS 206 with respect to the RESTAURANT entity set and the TABLE entity set 204. The total participation constraint requires that all entities in the entity set must participate in at least one relationship in the relationship set. Moreover, a total participation constraint 210 is enforced on the relation ‘Contains’ between the MENU entity and the ITEM entity. A reservation code is established as a key attribute referencing the TABLE entity set.

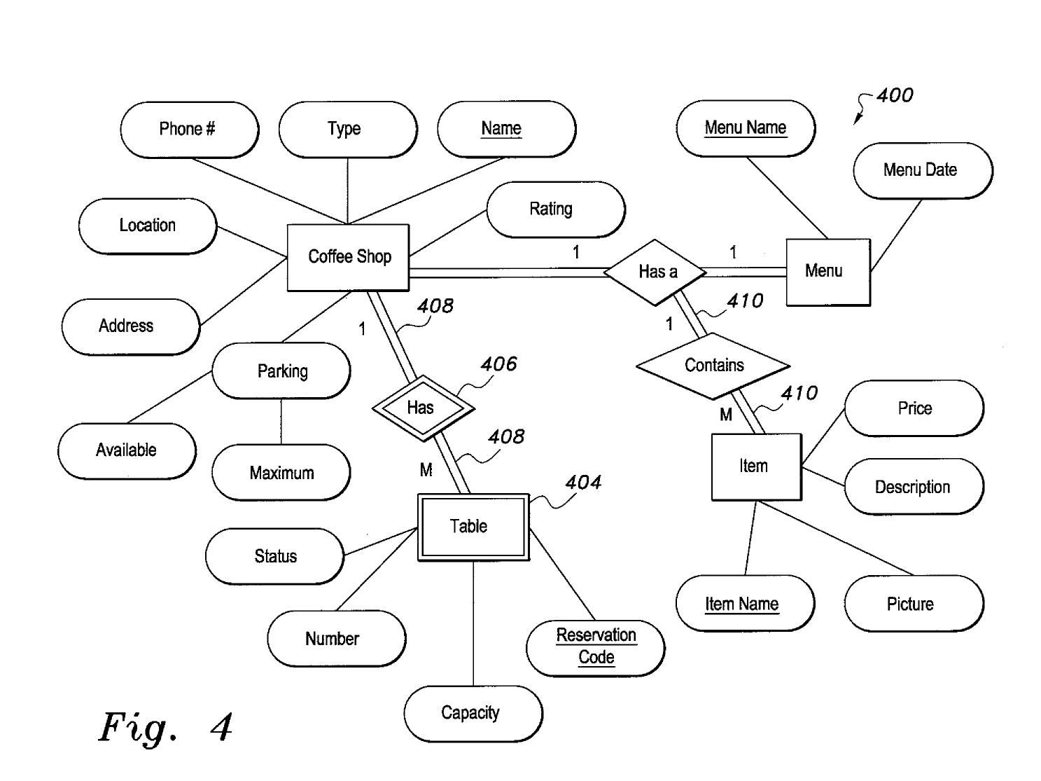

The users can retrieve the food items through their mobile devices 20 to decide whether to reserve a table in the restaurant. Similarly, in the Coffee shop ER diagram 400 of FIG. 4, TABLE 404 is declared to be a weak entity set and the total participation constraint 408 is enforced on the relation HAS 406 with respect to the COFFEE SHOP entity and TABLE 404 entity. Moreover, a total participation constraint 410 is enforced on the relation ‘Contains’ between the MENU entity and the ITEM entity.

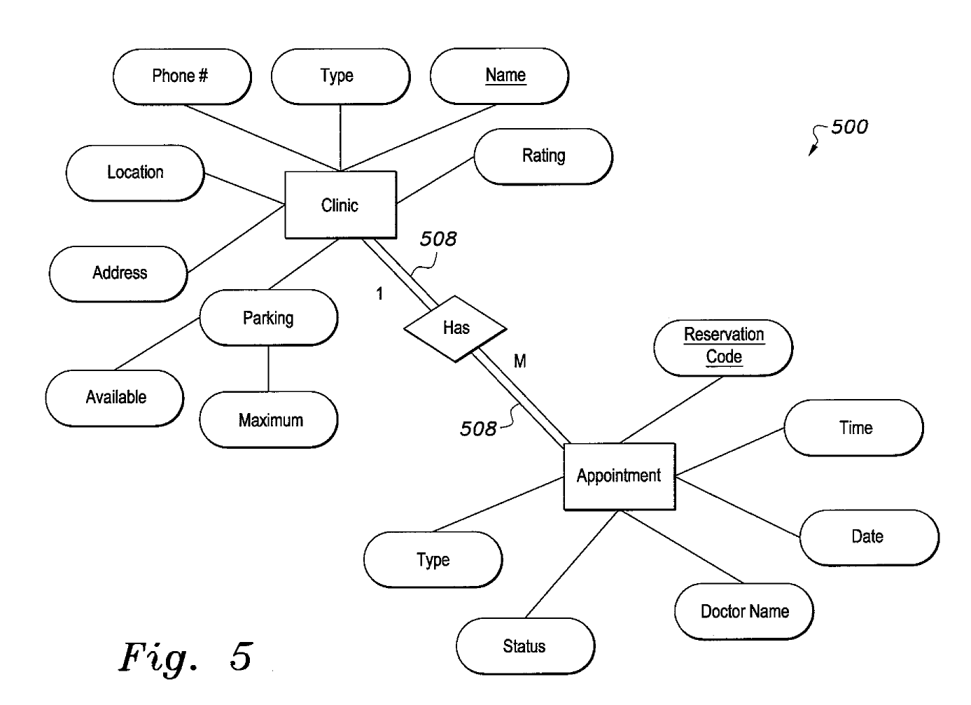

As shown in FIG. 10, process flow 1000 illustrates the use case wherein an end user can make an appointment from among nearby clinics, which are presented by the system 10 to the user's mobile device 20. The PHP code 120 includes a main screen for the clinic table, where a clinic employee can insert the data needed, such as the clinic attributes shown in the clinic ER diagram 500 of FIG. 5. The total participation constraint 508 is enforced on the relation HAS with respect to the CLINIC and APPOINTMENT entities.

Information can be retrieved from the database 130 and can be shown to end users' mobile devices 20 when using the mobile application 22. An end user is allowed to make a quick search for a word or part of it by entering text in the required search field in a quick search area. When an end user schedules a clinic appointment using the mobile application 22, the mobile application 22 will access the appropriate relation (as shown in FIG. 5 ER diagram 500) and automatically add the information. The mobile user is then presented confirmation of an acceptable appointment time, parking availability, and the like. The users can accept the confirmation through their mobile devices 20.

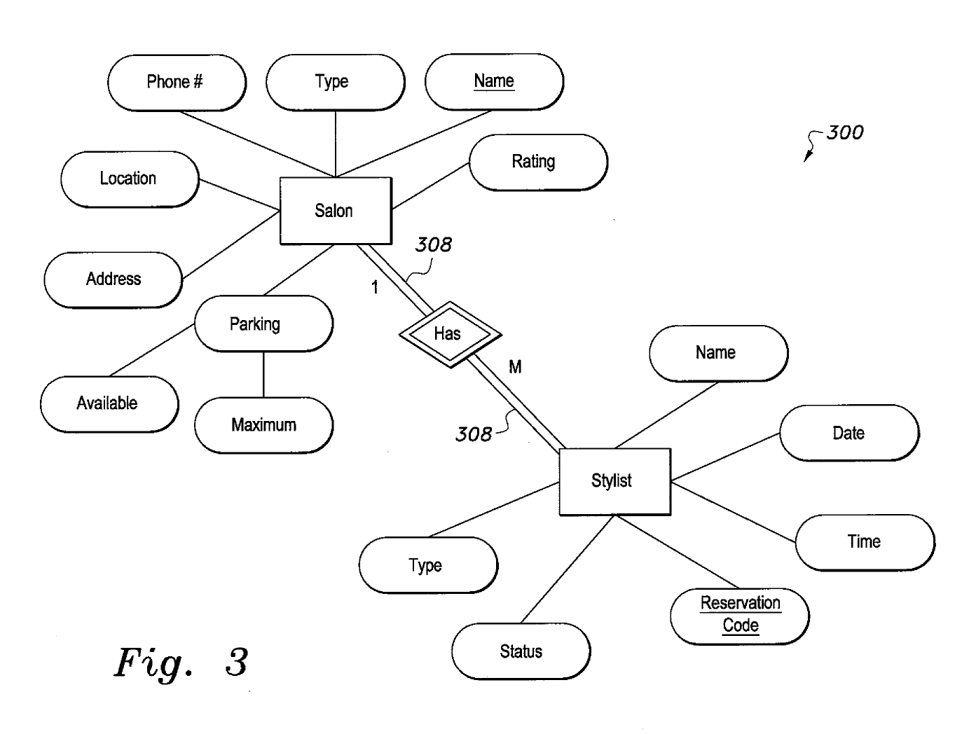

As shown in FIG. 11, process flow 1100 illustrates the use case wherein an end user can make an appointment from among nearby hair salons, or the like, which are presented by the system 10 to the user's mobile device 20. The PHP code 120 includes a main screen for the salon table, where a salon employee can insert the data needed, such as the salon and stylist attributes shown in the salon ER diagram 300 of FIG. 3. Moreover, a total participation constraint 308 is enforced on the relation ‘Has’ between the SALON entity and the STYLIST entity.

Information can be retrieved from the database 130 and can be shown to end users' mobile devices 20 when using the mobile application 22. An end user is allowed to make a quick search for a word or part of it by simply entering text in the required search field in a quick search area. When an end user schedules a salon appointment using the mobile application 22, the mobile application 22 will access the appropriate relation (as shown in FIG. 3 ER diagram 300) and automatically add the information. The mobile user is then presented confirmation of an acceptable appointment time, parking availability, and the like. The users can accept the confirmation through their mobile devices 20.

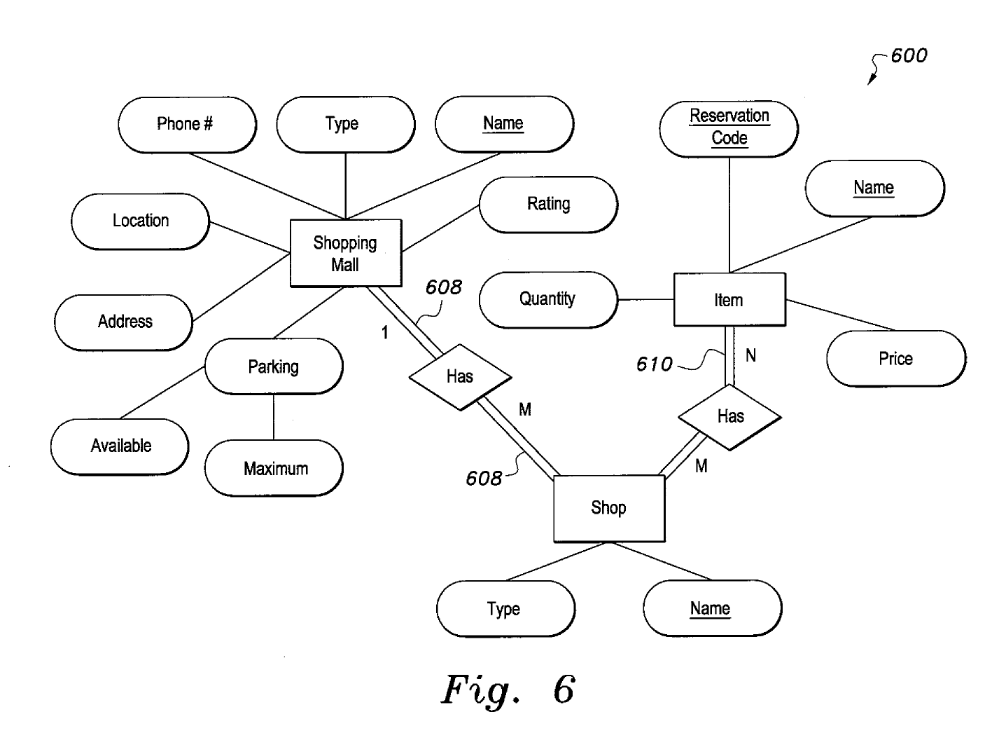

As shown in FIG. 9, process flow 900 illustrates the use case wherein an end user can locate and purchase items from among nearby shopping malls or similar establishments, which are presented by the system 10 to the user's mobile device 20. The PHP code 120 includes a main screen for the mall table, where a mall employee can insert the data needed, such as the mall and shop attributes shown in the shopping mall ER diagram 600 of FIG. 6. The total participation constraint 608 is enforced on the relation HAS with respect to the SHOPPING MALL and SHOP entities. Moreover, a total participation constraint 610 is enforced on the relation ‘Has’ between the SHOP entity and the ITEM entity. It is expected that owner/employees of individual shops would update the ITEM table and its associated attributes.

Information can be retrieved from the database 130 and can be shown to end users' mobile devices 20 when using the mobile application 22. An end user is allowed to make a quick search for a word or part of it by entering text in the required search field in a quick search area. When an end user searches for an item in a shopping mall shop using the mobile application 22, the mobile application 22 will access the appropriate relation (as shown in FIG. 6 ER diagram 600) and automatically add the information. The mobile user is then presented confirmation of purchase or hold, parking availability, and the like. The users can accept the confirmation through their mobile devices 20.

The ROSS user base is potentially every mobile user and every service oriented company. Also ROSS is easily distributed online for the end users and easily procured for service-oriented companies. Moreover, since the system 10 is an LBS, it provides a novel way for the end user to locate what is desired, when it is desired.

The reservation function takes the user's mobile phone number, time, and date as input and reserves the needed service and is expressed by the following pseudo-code:

// when the button—SEND—is pressed perform the following
Take the phone number, time, and date from the text fields
Call the servlet and give it the appropriate data (phone number, time, date)

### // End Reserve

The order function, when invoked, returns the target merchant or service's menu to the user and displays it on the user's mobile device and is expressed by the following pseudo-code:

// when the button—GET MENU—is pressed perform the following
Call the servlet that will communicate with the target's server
Fetch the menu items
Display results on-screen

### // End Order

The Servlets provide Internet aware functionality and are expressed by the following pseudo-code:

//Get the HTTP servlet request
Post the HTTP servlet request
Connect to the database through java database connectivity
Process the request by executing the appropriate SQL statement
Fetch and execute the SQL statement
Return the result.//

The system 10 is designed to be very user friendly. The graphical user interface of the mobile application 22 should have both graphical and text icons. In addition, the program can vocally pronounce each icon in the software. Furthermore, the application 22 supports multiple languages, such as Arabic, English, French, German, Persian, and Italian. There is voice recognition embedded in the mobile application software 22 for those people who are blind or otherwise visually impaired. The system contemplates integration of the software with the web (WWW) to allow the user to read different reviews about restaurants, hospitals, shopping malls, hotels and barber shops.

Using the ROSS system 10 is very easy and straightforward. Once an end user downloads it on his/her Wi-Fi enabled phone, the user can immediately harness ROSS. The end user will simply navigate the menu of mobile device 20 and open the ROSS icon among the applications, and then from the main menu, the user can navigate to choose any of the desired options, as shown therein. The user would then press the button on the mobile device 20 with the indicated functions that appear on the bottom edge of the mobile unit 20. From there the user can choose from services, such as Restaurants, Coffee Shops, Clinics, Salons, or an ‘About’ help option. The ROSS system 10 is not limited to these options. It could include any desired destinations such as barber shops/hair salons or hotels.

The system changes the way that companies reach their clients by allowing companies to broadcast their advertisements, offers and services. Users will receive these ads, offers and services through their mobile devices 20, and the messages are certain to reach each user.

Unlike ordinary and conventional advertisements and media that reach a select few audience and cost hundreds of thousands of dollars, the system reaches a wide demographic, effectively and very economically.

It will be understood that the diagrams in the Figures depicting the method for wireless reservation and ordering from a mobile device are exemplary only, and may be embodied in a dedicated electronic device having a microprocessor, microcontroller, digital signal processor, application specific integrated circuit, field programmable gate array, any combination of the aforementioned devices, or other device that combines the functionality of the method for wireless reservation and ordering from a mobile device onto a single chip or multiple chips programmed to carry out the method steps described herein, or may be embodied in a general purpose computer or distributed network of general purpose computers having the appropriate peripherals attached thereto and software stored on a computer readable media that can be loaded into main memory and executed by a processing unit to carry out the functionality of the inventive apparatus and steps of the inventive method described herein.

It is to be understood that the present invention is not limited to the embodiment described above, but encompasses any and all embodiments within the scope of the following claims.

We claim:

1. A computer-implemented mobile wireless reservation and ordering method comprising the steps of:
connecting a client wireless mobile device to a wireless local area network in proximity to the mobile device;
using a software application stored on the mobile device, displaying on the mobile device a selection menu of products and services available locally from merchants having information stored in a remote database accessible through a target server in communication with the mobile device via connection to the wireless local area network;
using the mobile device user interface, making selections from the selection menu, the selections specifying a user's order for at least one of the local products and services displayed on the mobile device selection menu;
sending the user specified order to the target server via the wireless local area network, the order including a reserved time slot for acceptance of the order;
receiving confirmation of the order from the target server, the confirmation including confirmation of availability of the selected order and confirmation of the reserved timeslot for acceptance of the order; and
using the application software, displaying the confirmation on the mobile device to the mobile device user.

2. The computer-implemented mobile wireless reservation and ordering method according to claim 1, wherein said method steps are performed by the application software by execution on a processor of said mobile device.

3. The computer-implemented mobile wireless reservation and ordering method according to claim 2, wherein the application software is at least one J2ME Mid let.

4. The computer-implemented mobile wireless reservation and ordering method according to claim 2, wherein said making selections step further comprises the step of entering the user's cell phone number, service requested, and time and date desired for the service being ordered.

5. The computer-implemented mobile wireless reservation and ordering method according to claim 4, wherein said confirmation displaying step further comprises displaying an available time and date for the locally available product or service ordered by the user.

6. A computer-implemented mobile wireless reservation and ordering method, comprising the steps of:
providing a database server running a relational database management system (RDBMS);
providing a relational database managed by the RDBMS, the database having stored thereon information describing a plurality of products and services locally available;
operably connecting the relational database to a wireless local network, the products and services being location-based in proximity to the wireless local network;
automatically translating a user order for at least one of the products and services into an SQL language query to the relational database, the order being user-selected from a menu on a mobile device and wirelessly transmitted from the mobile device to the relational database;
automatically formulating a result to the query, the result including confirmation of availability of the order and confirmation of a reservation time of the order; and
wirelessly transmitting the query result for display on the user's mobile device.

7. The computer-implemented mobile wireless reservation and ordering method according to claim 6, further comprising the step of: establishing within said database a weak entity relationship between a dominant entity representing a provider of at least one of said products and services and a weak entity representing an item that provider has locally available.

8. The computer-implemented mobile wireless reservation and ordering method according to claim 6, further comprising the step of: establishing a total participation constraint requiring that all entities in a SALON entity set and all entities in a STYLIST entity set stored in said database must participate in at least one relationship in a HAS relationship set, wherein a first of said services is a salon service having a plurality of stylists.

9. The computer-implemented mobile wireless reservation and ordering method according to claim 6, further comprising the step of: establishing a total participation constraint requiring that all entities in a CLINIC entity set and all entities in an Appointment entity set stored in said database must participate in at least one relationship in a HAS relationship set, wherein a second of said services is a clinic service having a plurality of available appointments.

10. The computer-implemented mobile wireless reservation and ordering method according to claim 6, further comprising the steps of:
establishing a total participation constraint requiring that all entities in a SHOPPING MALL entity set and all entities in a SHOP entity set stored in said database must participate in at least one relationship in a HAS relationship set, wherein a third of said services is a SHOPPING MALL service having a plurality of SHOPS; and
establishing a total participation constraint requiring that all entities in said SHOP entity set and all entities in an ITEM entity set must participate in at least one relationship in a HAS relationship set.

11. The computer-implemented mobile wireless reservation and ordering method according to claim 7, wherein said dominant entity is a tabular list of restaurants and said weak entity is a tabular list of tables related to each of the restaurants, wherein a fourth of said services is a restaurant service having a plurality of seating tables.

12. The computer-implemented mobile wireless reservation and ordering method according to claim 7, wherein said dominant entity is a tabular list of coffee shops and said weak entity is a tabular list of tables related to each of said coffee shops, wherein a fifth of said services is a coffee shop service having a plurality of seating tables.

13. The computer-implemented mobile wireless reservation and ordering method according to claim 7, wherein said query formulating step further comprises mediating transfer of order information between said mobile application and said relational database via an application server connected to a web server, said application server transferring said order information to said web server, and said web server transferring said order information to said relational database server.

14. The computer-implemented mobile wireless reservation and ordering method according to claim 13, further comprising the step of providing a third party query filtering application accessible via web pages available from said web server, thereby allowing administrative users to maintain said relational database without utilizing complex query statements.

15. The computer-implemented mobile wireless reservation and ordering method according to claim 11, further comprising the step of establishing a total participation constraint requiring that all entities in the Restaurant entity set and all entities in the Table entity set must participate in at least one relationship in a HAS relationship set.

16. The computer-implemented mobile wireless reservation and ordering method according to claim 11, further comprising the step of establishing a total participation constraint requiring that all entities in a Menu entity set and all entities in an Item entity set must participate in at least one relationship in a CONTAINS relationship set.

17. The computer-implemented mobile wireless reservation and ordering method according to claim 12, further comprising the step of establishing a total participation constraint requiring that all entities in a Menu entity set and all entities in an Item entity set must participate in at least one relationship in a CONTAINS relationship set.

18. A mobile wireless reservation and ordering system, comprising:
means for serving a relational database, thereby allowing storage, update and retrieval of information to and from the relational database, the information describing availability of a plurality of products and services;
means for operably connecting the relational database to a wireless local network, the products and services being location based in proximity to the wireless local network;
means for formulating a query of the relational database, the relational database query being based on a user order for at least one of the products and services, the order being user-selected from a menu on a mobile device and wirelessly transmitted from the mobile device to the relational database;
means for formulating a result to the query, the result including confirmation of availability of the order and confirmation of a reservation time of the order, the query result being wirelessly transmitted for display on the user's mobile device.

19. The mobile wireless reservation and ordering system according to claim 18, further comprising means for distributing a custom mobile software application executable on a processor of said mobile device, said custom mobile software application providing said product and service order selection functionality of said mobile device.

20. The mobile wireless reservation and ordering system according to claim 18, further comprising:
means for establishing within said database a weak entity having a relationship between a dominant entity representing at least one of said products and services, said weak entity representing an item that said at least one of said products and services provides; and
means for establishing a total participation constraint between at least two related entities in said relational database.
